(19) United States
(12) Patent Application Publication
(10) Pub. No.: US 2022/0363224 A1
(43) Pub. Date: Nov. 17, 2022

(54) DEVICE FOR DISCHARGING LIQUIDS FOR A MODULE COMPRISING SENSOR/TRANSMITTER BLOCKS FOR A VEHICLE

(71) Applicant: Valeo Systemes d'Essuyage, La Verriere (FR)

(72) Inventors: Christophe CHASSAING, La Verriere (FR); Maxime BAUDOUIN, La Verriere (FR); Baptiste BEZIAT, La Verriere (FR)

(73) Assignee: Valeo Systemes d'Essuyage, La Verriere (FR)

(21) Appl. No.: 17/619,309

(22) PCT Filed: Jun. 16, 2020
(86) PCT No.: PCT/EP2020/066651

§ 371 Date: Dec. 15, 2021

(30) Foreign Application Priority Data
Jun. 28, 2019 (FR) 1907223

(51) Int. Cl. B60S 1/48; B60S 1/56; G02B 27/00

(52) U.S. Cl. CPC B60S 1/48; B60S 1/56; G02B 27/0006; G01S 2007/4977

(57) ABSTRACT

The device for discharging liquids for a module includes sensor/transmitter blocks for a vehicle. The module includes a first block having a lower optical surface having an upper limit, and at least one second block having at least one upper optical surface with a lower limit arranged above the lower optical surface. The device extends from an area defined by at least one portion of the lower limit of the at least one second block and the upper limit of the first block, and is configured to discharge liquids flowing from the at least one upper optical surface to an area other than the lower optical surface.

### CROSS-REFERENCE TO RELATED APPLICATIONS

This is a 371 application (submitted under 35 U.S.C. § 371) of International Application No. PCT/EP2020/066651 (WO2020/260075) filed on Jun. 16, 2020, which claims priority date benefit to French Application No. 1907223 filed Jun. 28, 2019, the disclosures of which are incorporated herein by reference in their entirety.

### TECHNICAL FIELD

Embodiments of the invention relate to devices for discharging liquids, more particularly devices for discharging liquids for a module comprising sensor/transmitter blocks for a vehicle.

### BACKGROUND

With the worldwide development of new technologies in the automotive sectors, motor vehicles are increasingly being equipped with automated systems, in particular automated driving assistance systems which make it possible, with a lower degree of autonomy of the vehicle, to assist with or to carry out parking maneuvers and also, with a maximum degree of autonomy of the vehicle, to drive the vehicle without a driver being present in the vehicle.

Such driving assistance systems for a vehicle have in particular one or more detection devices equipped with sensors/transmitters configured to detect an environment around the vehicle and to evaluate parameters external to the vehicle. The vehicle comprises at least one control unit that is coupled to said sensors/transmitters and configured to analyze information collected by the sensors/transmitters and make decisions that arise on the basis of this information.

In particular, a high-level autonomous vehicle, for example starting from level 4 according to the classification of the International Organization of Motor Vehicle Manufacturers, involves the use of a plurality of optical sensors/transmitters disposed all around the vehicle in order to very precisely take into account the environment around the vehicle.

To this end, the optical sensors/transmitters are generally disposed as close together as possible so as to form one or more sensor/transmitter blocks with for example first optical sensors/transmitters that are able to reproduce one or more images of a road scene by transmitting and receiving waves, in particular by laser imaging, detection and ranging (LIDAR), and second optical sensors of the viewing camera type.

### SUMMARY

The resolution of the image acquired by the viewing cameras and the three-dimensional representation allowed by the laser detection modules make it possible to reliably image the road scene around the vehicle.

In order to have a wider detection field of view, the second optical sensors of the viewing camera type are generally disposed above the first sensors/transmitters. By way of indication, the first and second sensors/transmitters can be located in the region of the roof, of the rear or front bumpers of the vehicle, of the rear or front license plate of the vehicle, or on the sides of the vehicle or the side-view mirrors thereof.

Since the optical sensors/transmitters are generally disposed outside the vehicle, each sensor/transmitter is greatly exposed to being spattered with organic or inorganic dirt which can be deposited on the optical surface thereof. The resultant deposition of dirt reduces the effectiveness of the optical sensors/transmitters, or even makes them inoperative. In particular, during periods of wet weather, rain and dirt is observed to spatter, and this may have a significant negative effect on the operability of the driving assistance system comprising such sensors/transmitters. Therefore, the optical surfaces of the sensors/transmitters have to be cleaned individually in order to ensure that they remain in a good operating state.

In order to meet this need, there exist cleaning systems suitable for several sensors/transmitters, which allow the sensors/transmitters to be cleaned simultaneously or individually.

However, during simultaneous cleaning of a first sensor/transmitter and of a second sensor/transmitter disposed above the first sensor/transmitter or during individual cleaning of said second sensor/transmitter, it is very likely that the first sensor/transmitter will be soiled by dirty cleaning liquids that are used during said simultaneous cleaning or during said individual cleaning of the second sensor/transmitter.

These dirty cleaning liquids can, for example, run directly or indirectly off the second sensor/transmitter toward the optical surface of the first sensor/transmitter, thereby reducing the performance of said simultaneous cleaning or the functional performance of the soiled first sensor/transmitter.

There is thus a need to propose a technical solution of low complexity and low cost that makes it possible to avoid any contamination of the optical surface of a sensor/transmitter by dirty liquids coming from at least one other sensor/transmitter disposed above said sensor/transmitter.

According to one aspect, a device for discharging liquids for a module comprising sensor/transmitter blocks for a vehicle is proposed.

Said module comprises
a first block having a lower optical surface having a top limit,
at least one second block having at least one upper optical surface disposed above the lower optical surface, and
the at least one second block comprising a bottom limit.

Said device extends from an area delimited by at least a part of the bottom limit of the at least one second block and the top limit of the first block, and is configured to discharge liquids running off the at least one upper optical surface toward an area other than the lower optical surface.

The use of such a device for discharging liquids advantageously makes it possible to avoid a situation in which dirty liquids used during the cleaning of said at least one second block fall onto the lower optical surface of the first block so as to keep the lower optical surface clean.

At the same time, during simultaneous cleaning of the set of blocks of the module, the cleaning performance for the first block and thus for the whole of the module is also improved.

It should be noted that the position of said device is not limited to the bottom limit of the at least one second block or to the top limit of the first block. It is, for example, also possible to dispose the device for discharging liquids between said top limit and said bottom limit.

Moreover, if the module comprises several sensor/transmitter blocks, the first block is not systematically the block that is located in the bottommost position of the module but may also be an intermediate block surmounted by at least one second block.

According to one embodiment, said at least one second block is superposed on the first block, and each of said at least one upper optical surface and the lower optical surface are in the longitudinal continuation of one another.

Indeed, the first and said at least one second block of said module are superposed on top of the other.

Said at least one upper optical surface and the lower optical surface may be inclined in an identical manner with respect to the horizontal plane, being for example perpendicular to the horizontal plane here.

According to another embodiment, said at least one upper optical surface and the lower optical surface are disposed in a first part of the module and the device is configured to discharge liquids running off said at least one upper optical surface toward a second part of the module. The second part is different than the first part.

By way of nonlimiting example, the first part may comprise a front part of the module and the second part may comprise a rear part of the module.

Consequently, the dirty liquids coming from said at least one upper optical surface are advantageously discharged toward the second part without contaminating the first part.

The first block may be for example at a distance from said at least one second block.

In other words, there may be a space between the first block and said at least one second block. As indicated above, it is possible, in this case, to dispose the device in this space.

When there are several second blocks, it is possible for the device to be disposed close to the top limit of the first block or close to the bottom limit of each second block so as to prevent dirty liquids coming from said at least one second block from running off onto the lower optical surface.

By way of nonlimiting example, the device may be, for example, inclined with respect to the horizontal.

Advantageously, such a device may form an inclination angle so as to make it easier to discharge the dirty liquids.

According to another embodiment, the device has at least one channel.

If there are several second blocks, it is possible for each second block to have a channel.

Said at least one channel may, for example, have in each case a semi-open cavity, the size of which is designed so as to have a liquid discharging flow rate of between 5 and 40 ml/s.

It will be understood here that the size of each channel depends potentially on the shape and the size of an associated first or second block. A person skilled in the art knows how to adapt the size of each channel so as to have a liquid discharging flow rate of between 5 and 40 ml.

According to another aspect, a cleaning system for a module comprising sensor/transmitter blocks for a vehicle is proposed.

Said module has
a first block having a lower optical surface having a top limit,
at least one second block having at least one upper optical surface disposed above the lower optical surface, and
the at least one second block comprising a bottom limit.

The cleaning system comprises a device for discharging liquids as defined above.

According to yet another aspect, a driving assistance system comprising at least one cleaning system as defined above is proposed.

### BRIEF DESCRIPTION OF THE DRAWINGS

Further advantages and features of the invention will become apparent from studying the detailed description of entirely nonlimiting embodiments and the appended drawings, in which:

FIG. 1 schematically illustrates an exemplary embodiment of a motor vehicle having a driving assistance device.

FIG. 2 schematically illustrates an exemplary embodiment of a driving assistance device comprising a device for discharging liquids according to the invention.

FIG. 3 schematically illustrates an exemplary embodiment of a device for discharging liquids according to the invention.

FIG. 4 schematically illustrates an exemplary embodiment of a driving assistance device and of a corresponding device for discharging liquids according to the invention.

FIG. 5 schematically illustrates another exemplary embodiment of a driving assistance device and of a corresponding device for discharging liquids according to the invention.

### DETAILED DESCRIPTION

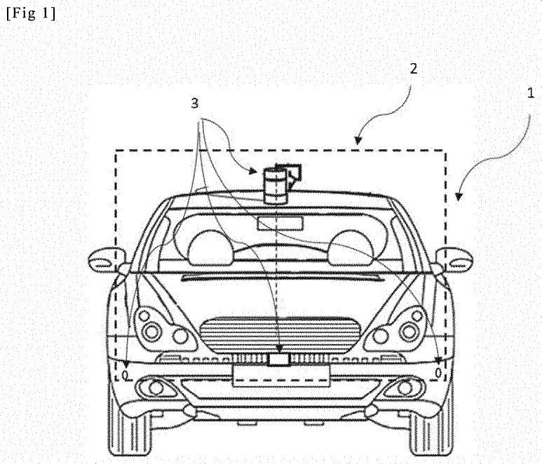

The reference 1 in FIG. 1 denotes a vehicle, in this case for example a motor vehicle, comprising a driving assistance device 2.

The driving assistance device 2 has one or more modules, in this case for example one or more detection modules 3 configured to collect different information relating to the environment around the vehicle 1.

The detection module(s) 3 may be disposed at one or more locations on the vehicle 1, for example in the region of the roof, of the windshield, of the rear and/or front bumpers of the vehicle 1.

By way of nonlimiting example, the detection modules 3 may for example include
long-range laser sensors/transmitters of the LIDAR (“Laser Imaging, Detection and Ranging”) type configured to detect the environment,
viewing cameras having different levels of range,
front sensors/transmitters configured to measure the distance between the vehicle 1 and the vehicles ahead of it,
angle sensors/transmitters configured to monitor movements around the vehicle,
ultrasonic sensors/transmitters configured to detect obstacles in the vicinity of the vehicle, and
180° panoramic cameras configured to allow the driver and passengers of the vehicle 1 to view the environment around the vehicle.

Some of the sensors/transmitters mentioned above may be, for example, disposed in one and the same location of the vehicle 1 in order to reduce the space requirement of the detection module(s) 3.

For reasons of simplification, only one detection module 3 of the driving assistance device 2 is illustrated in FIG. 1, being for example disposed in the region of the roof of the vehicle 1 in this case.

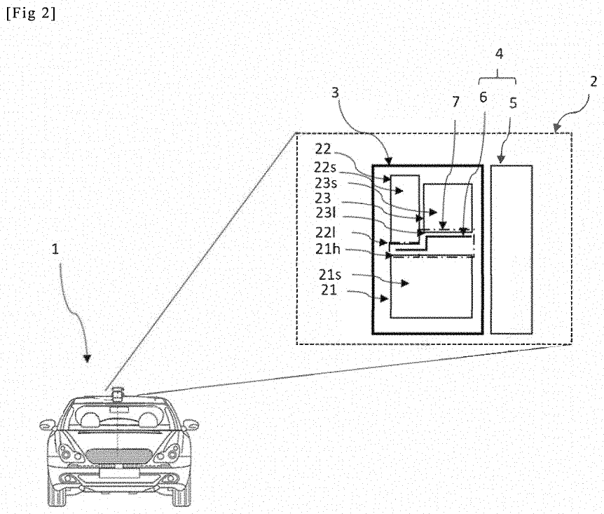

Reference will now be made to FIG. 2 for schematically illustrating an exemplary embodiment of the detection module 3.

In this example, the detection module 3 has

a first sensor/transmitter 21, in this case for example a laser sensor of the LIDAR type,

a second sensor/transmitter 22, in this case for example a long-range viewing camera, disposed above the first sensor/transmitter 21, and

a third sensor/transmitter 23, in this case for example a medium-range viewing camera, likewise disposed above the first sensor/transmitter 21 and next to the second sensor/transmitter 22.

The first sensor/transmitter 21 has a first optical surface 21s having a top limit 21h. The second and third sensors/transmitters 22, 23 have a second optical surface 22s and a third optical surface 23s, respectively. The second and third optical surfaces 22s, 23s have a second bottom limit 22l and a third bottom limit 23l, respectively. The third bottom limit 23l is in this case disposed for example at a higher level than the second bottom limit 22l.

In the example illustrated in FIG. 2, the first, second and third optical surfaces 21s, 22s and 23s are flat surfaces and lie substantially in one and the same vertical plane.

Each of the second and third bottom limits 22l, 23l covers at least a part of the first top limit 21h of the first optical surface 21s. In this case, the combination of the second and third bottom limits 22l, 23l covers more or less the entire first top limit 21h of the first optical surface 21s.

The driving assistance device 2 also comprises, for each detection module 3, at least one cleaning system, in this case for example a cleaning system 4 for the detection module 3.

The cleaning system 4 comprises one or more cleaning devices 5 such as wipers configured to clean the first, second and third optical surfaces 21s, 22s, 23 s of the detection module 3 and a device 6 for discharging liquid.

The device 6 for discharging liquids is configured to avoid a situation in which in particular dirty liquids run from the at least one upper optical surface of the detection module 3, in this case the second and third optical surfaces 22s, 23s, toward an optical surface disposed beneath said at least one upper optical surface, in this case the first optical surface 21s.

In other words, the device 6 for discharging liquids is configured to discharge the liquids running off the second and third optical surfaces 22s, 23s toward an area other than the first optical surface 21s.

It should be noted that said liquids may be for example used and dirty cleaning liquids that have been used for cleaning the second and third optical surfaces 22s, 23s or raindrops on these second and third optical surfaces 22s, 23s.

By way of example, if the first, second and third optical surfaces 21s, 22s, 23s are disposed on the front face of the detection module 3, the device 6 for discharging liquids may be configured to discharge said liquids toward the side faces or the rear face of the detection module 3.

Since the third bottom limit 23l is situated at a higher horizontal level than that of the second bottom limit 22l, the device 6 for discharging liquids is also configured to discharge liquids running off the third optical surface 23s toward an area other than the second optical surface 22s.

The device 6 for discharging liquids extends from an area 7 delimited by at least a part of the second or third bottom limit 22l, 23l of the at least one second or third optical surface 22s, 23s and said first top limit 21h of the first optical surface 21s.

In other words, the device 6 for discharging liquids may extend from a part of the second or the third bottom limit 22l or 23l or from a part of the first top limit 21h, or from a location between the second or the third bottom limit 22l, 23l of a second or of a third optical surface 22s, 23s and the first top limit 21h as long as the liquids running off the second and/or the third optical surface 22s, 23s are discharged toward an area other than the first optical surface 21s.

By way of nonlimiting example, the first, second and third optical surfaces 21s, 22s, 23s may also not be disposed in one and the same vertical plane. In that case, the shape of the device 6 for discharging liquids is designed to discharge said liquids toward an area other than the first and second optical surfaces 21s, 22s.

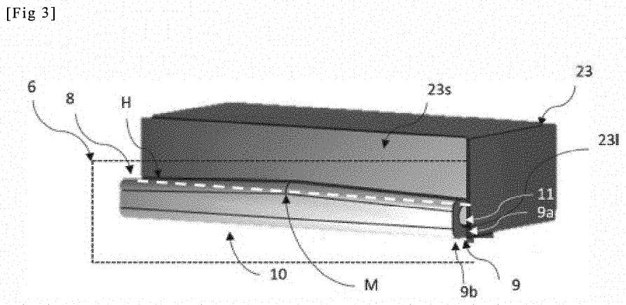

Reference will now be made to FIG. 3 for illustrating an exemplary embodiment of the device 6 for discharging liquids.

It should be noted that the device 6 for discharging liquids may be made in different embodiments, for example channels on their own or channels in combination with drainage pipes, known to a person skilled in the art.

By way of indication, the device 6 has a channel 8 extending from the bottom limit of an optical surface, in this case for example the third bottom limit 23l of the third optical surface 23s in the form of a semi-open cavity that opens upwardly.

The channel 8 comprises

a base 9, one lateral side 9a of which is secured to the third bottom limit 23l, and

a side wall 10 secured to the other lateral side 9b of the base 9.

A central discharging duct 11 is therefore formed by the base 9, the side wall 10 and the third bottom limit 23l.

It should be noted that the channel 8 may be secured to at least a part of the third bottom limit 23l by any means known to a person skilled in the art, for example by glue, by welding, or by mechanical holding.

The channel 8 may also have drainage pipes (not shown) connected to longitudinal ends of the central discharging duct 11 so as to discharge used and dirty liquids toward an area other than the first and second optical surfaces 21s, 22s.

In order to make it easier to discharge liquids, the channel 8 may also be inclined with respect to the horizontal H, in this case for example inclined from the mid-point M of the channel 8 toward the two longitudinal ends of the central discharging duct 11.

The channel 8 may for example be molded from plastic in one piece, or be attached by welding or by any other fastening means known to a person skilled in the art.

The dimensions of the central discharging duct 11 and of any drainage pipes may be designed in an adaptive manner so as to achieve an intended liquid discharging flow rate.

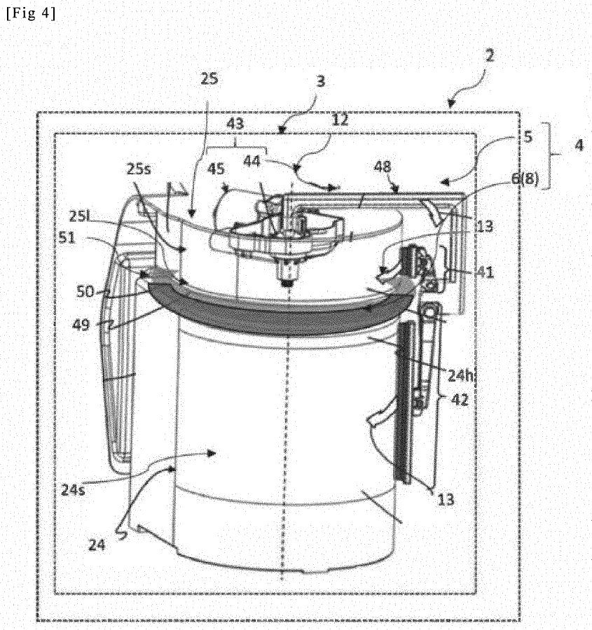

Reference will now be made to FIG. 4 for illustrating another embodiment of the driving assistance device 2 and of the corresponding device 6 for discharging liquids.

The driving assistance device 2 is fastened to the roof of a vehicle and centered on the roof of the vehicle and comprises a detection module 3 comprising at least two sensors/transmitters, in this case for example a fourth sensor/transmitter 24 and a fifth sensor/transmitter 25 which are superposed one on top of the other along an axis of rotation 12.

It should be noted that the position and the number of sensor(s)/transmitter(s) could be different that those presented in FIG. 4, without having a negative effect on the scope of the invention.

By way of example, the fourth sensor/transmitter 24 is a viewing camera and the fifth sensor/transmitter 25 is a LIDAR sensor.

The fourth sensor/transmitter 24 has a fourth optical surface 24s having a fourth top limit 24h and the fifth sensor/transmitter 25 has a fifth optical surface 25s having a fifth bottom limit 251.

The fourth optical surface 24s and the fifth optical surface 25s are in the longitudinal continuation of one another, such that one or the other does not protrude radially with respect to the other optical surface.

The driving assistance device 2 also comprises a cleaning system 4 having a cleaning device 5 mounted so as to be rotatable about the axis of rotation 12. The rotational movement is illustrated by arrows 13.

The cleaning device 5 comprises a first cleaning assembly 41, a second cleaning assembly 42, and a device 43 for driving these two cleaning assemblies simultaneously in rotation, which has a crank 44 and an electric motor 45.

The first cleaning assembly 41 is intended to clean the fifth optical surface 25s of the fifth sensor/transmitter 25 by wiping and the second cleaning assembly 42 is intended to clean the fourth optical surface 24s of the fourth sensor/transmitter 24.

The electric motor 45 is able to drive the cleaning device 5 in rotation about the axis of rotation 12. In other words, the electric motor 45 simultaneously drives the first cleaning assembly 41 and the second cleaning assembly 42 in rotation.

The crank 44 connects the first cleaning assembly 41 and the second cleaning assembly 42 to the electric motor 45. The crank 44 comprises at least one main arm, in this case for example a main arm 48 extending radially with respect to the axis of rotation 12.

As illustrated in FIG. 4, the main arm 48 is disposed, in this exemplary embodiment, above the fifth sensor/transmitter 25.

The fifth optical surface 25s and the fourth optical surface 24s have a regular curved and semi-cylindrical shape, both being coaxial and centered on the axis of rotation 12.

The fourth and fifth optical surfaces 24s, 25s extend more or less through an angle of 180°, i.e. a half-cylinder, corresponding to the maximum field of view, of the fourth and fifth optical surfaces 24s, 25s, respectively.

The fourth sensor/transmitter 24 has a top wall 49 and the fifth sensor/transmitter 25 has a bottom wall 50. The top wall 49 is spaced apart from the bottom wall 50 so as to form a clearance zone 51 between the fourth and fifth sensors/transmitters 24, 25.

The clearance zone 51 represents a volume that extends radially from the axis of rotation 12. The clearance zone 51 stops in line with the fourth optical surface 24s and the fifth optical surface 25s.

The cleaning system 4 also has a device 6 for discharging liquids that is disposed starting from an area delimited by at least a part of the fifth bottom limit 251 and the fourth top limit 24h, in this case for example an area combining the fifth bottom limit 251, the fourth top limit 24h and the clearance zone 51.

By way of example, the device 6 for discharging liquids has a channel 8 that is disposed starting from the clearance zone 51 and has a regular curved and semi-cylindrical shape so as to adapt to the fourth top limit 24h.

The channel 8 may cover for example the entire fourth top limit 24 so as to discharge liquids running off the fifth optical surface 25s toward an area other than the fourth optical surface 24s.

The profile of the channel 8 may be designed so as not to impede the first and second cleaning assemblies 41, 42 and may for example be identical, namely in the form of a semi-open cavity, to the channel 8 illustrated in FIG. 3.

The size of the channel 8 may be determined in an adaptive manner so as to achieve an intended liquid discharging flow rate, in this case for example between 5 and 40 ml/s.

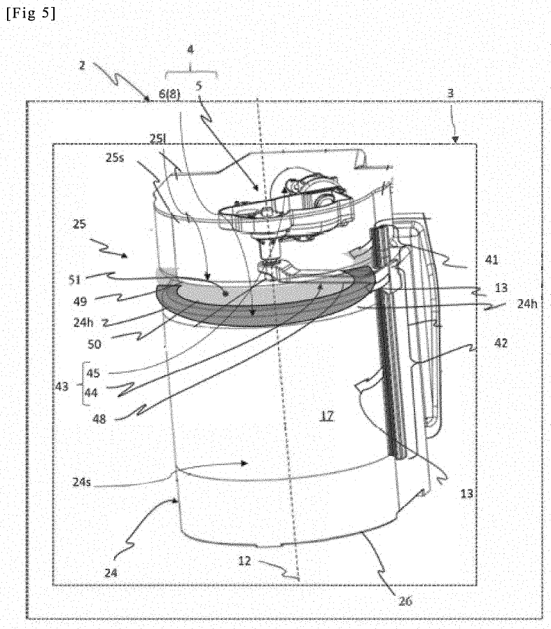

FIG. 5 illustrates a variant of the driving assistance device 2 according to FIG. 4.

In this exemplary embodiment, the main extension arm 48 of the cleaning device 5 is disposed in the clearance zone 51 and connected between the first cleaning assembly 41 and the second cleaning assembly 42.

The clearance zone 51 is configured such that the crank 43 can move in rotation about the axis of rotation 12 between a first end position and a second end position. In this case, the crank 43 is shown in the first end position, the second end position being situated around 180° from the first end position.

In order not to impede the movements of the main arm 48, the device 6 for discharging liquids may be disposed starting from the fourth top limit 24h and cover the entire fourth top limit 24h.

The structure of the device 6 for discharging liquids may be identical to or different than those illustrated in FIG. 3 and FIG. 4, and the size of the device 6 for discharging liquids may be determined in a manner adapted to an intended discharging flow rate.

It should be noted that the invention is not limited to the means and configurations described and illustrated above, but also extends to all equivalent means or configurations and to any technically functional combination of such means. In particular, the shape of the device 6 for discharging liquids may be modified without having a negative effect on the invention, provided that the device 6 for discharging liquids ultimately fulfills the same functionalities as those described in this document.

Embodiments of the invention relate to devices for discharging liquids, more particularly devices for discharging liquids for a module comprising sensor/transmitter blocks for a vehicle.

With the worldwide development of new technologies in the automotive sectors, motor vehicles are increasingly being equipped with automated systems, in particular automated driving assistance systems which make it possible, with a lower degree of autonomy of the vehicle, to assist with or to carry out parking maneuvers and also, with a maximum degree of autonomy of the vehicle, to drive the vehicle without a driver being present in the vehicle.

Such driving assistance systems for a vehicle have in particular one or more detection devices equipped with sensors/transmitters configured to detect an environment around the vehicle and to evaluate parameters external to the vehicle. The vehicle comprises at least one control unit that is coupled to said sensors/transmitters and configured to analyze information collected by the sensors/transmitters and make decisions that arise on the basis of this information.

In particular, a high-level autonomous vehicle, for example starting from level 4 according to the classification of the International Organization of Motor Vehicle Manufacturers, involves the use of a plurality of optical sensors/transmitters disposed all around the vehicle in order to very precisely take into account the environment around the vehicle.

To this end, the optical sensors/transmitters are generally disposed as close together as possible so as to form one or more sensor/transmitter blocks with for example first optical sensors/transmitters that are able to reproduce one or more images of a road scene by transmitting and receiving waves, in particular by laser imaging, detection and ranging (LIDAR), and second optical sensors of the viewing camera type.

The resolution of the image acquired by the viewing cameras and the three-dimensional representation allowed by the laser detection modules make it possible to reliably image the road scene around the vehicle.

In order to have a wider detection field of view, the second optical sensors of the viewing camera type are generally disposed above the first sensors/transmitters. By way of indication, the first and second sensors/transmitters can be located in the region of the roof, of the rear or front bumpers of the vehicle, of the rear or front license plate of the vehicle, or on the sides of the vehicle or the side-view mirrors thereof.

Since the optical sensors/transmitters are generally disposed outside the vehicle, each sensor/transmitter is greatly exposed to being spattered with organic or inorganic dirt which can be deposited on the optical surface thereof. The resultant deposition of dirt reduces the effectiveness of the optical sensors/transmitters, or even makes them inoperative. In particular, during periods of wet weather, rain and dirt is observed to spatter, and this may have a significant negative effect on the operability of the driving assistance system comprising such sensors/transmitters. Therefore, the optical surfaces of the sensors/transmitters have to be cleaned individually in order to ensure that they remain in a good operating state.

In order to meet this need, there exist cleaning systems suitable for several sensors/transmitters, which allow the sensors/transmitters to be cleaned simultaneously or individually.

However, during simultaneous cleaning of a first sensor/transmitter and of a second sensor/transmitter disposed above the first sensor/transmitter or during individual cleaning of said second sensor/transmitter, it is very likely that the first sensor/transmitter will be soiled by dirty cleaning liquids that are used during said simultaneous cleaning or during said individual cleaning of the second sensor/transmitter.

These dirty cleaning liquids can, for example, run directly or indirectly off the second sensor/transmitter toward the optical surface of the first sensor/transmitter, thereby reducing the performance of said simultaneous cleaning or the functional performance of the soiled first sensor/transmitter.

There is thus a need to propose a technical solution of low complexity and low cost that makes it possible to avoid any contamination of the optical surface of a sensor/transmitter by dirty liquids coming from at least one other sensor/transmitter disposed above said sensor/transmitter.

According to one aspect, a device for discharging liquids for a module comprising sensor/transmitter blocks for a vehicle is proposed.

Said module comprises
a first block having a lower optical surface having a top limit,
at least one second block having at least one upper optical surface disposed above the lower optical surface, and
the at least one second block comprising a bottom limit.

Said device extends from an area delimited by at least a part of the bottom limit of the at least one second block and the top limit of the first block, and is configured to discharge liquids running off the at least one upper optical surface toward an area other than the lower optical surface.

The use of such a device for discharging liquids advantageously makes it possible to avoid a situation in which dirty liquids used during the cleaning of said at least one second block fall onto the lower optical surface of the first block so as to keep the lower optical surface clean.

At the same time, during simultaneous cleaning of the set of blocks of the module, the cleaning performance for the first block and thus for the whole of the module is also improved.

It should be noted that the position of said device is not limited to the bottom limit of the at least one second block or to the top limit of the first block. It is, for example, also possible to dispose the device for discharging liquids between said top limit and said bottom limit.

Moreover, if the module comprises several sensor/transmitter blocks, the first block is not systematically the block that is located in the bottommost position of the module but may also be an intermediate block surmounted by at least one second block.

According to one embodiment, said at least one second block is superposed on the first block, and each of said at least one upper optical surface and the lower optical surface are in the longitudinal continuation of one another.

Indeed, the first and said at least one second block of said module are superposed on top of the other.

Said at least one upper optical surface and the lower optical surface may be inclined in an identical manner with respect to the horizontal plane, being for example perpendicular to the horizontal plane here.

According to another embodiment, said at least one upper optical surface and the lower optical surface are disposed in a first part of the module and the device is configured to discharge liquids running off said at least one upper optical surface toward a second part of the module. The second part is different than the first part.

By way of nonlimiting example, the first part may comprise a front part of the module and the second part may comprise a rear part of the module.

Consequently, the dirty liquids coming from said at least one upper optical surface are advantageously discharged toward the second part without contaminating the first part.

The first block may be for example at a distance from said at least one second block.

In other words, there may be a space between the first block and said at least one second block. As indicated above, it is possible, in this case, to dispose the device in this space.

When there are several second blocks, it is possible for the device to be disposed close to the top limit of the first block or close to the bottom limit of each second block so as to prevent dirty liquids coming from said at least one second block from running off onto the lower optical surface.

By way of nonlimiting example, the device may be, for example, inclined with respect to the horizontal.

Advantageously, such a device may form an inclination angle so as to make it easier to discharge the dirty liquids.

According to another embodiment, the device has at least one channel.

If there are several second blocks, it is possible for each second block to have a channel.

Said at least one channel may, for example, have in each case a semi-open cavity, the size of which is designed so as to have a liquid discharging flow rate of between 5 and 40 ml/s.

It will be understood here that the size of each channel depends potentially on the shape and the size of an associated first or second block. A person skilled in the art knows how to adapt the size of each channel so as to have a liquid discharging flow rate of between 5 and 40 ml.

According to another aspect, a cleaning system for a module comprising sensor/transmitter blocks for a vehicle is proposed.

Said module has
a first block having a lower optical surface having a top limit,
at least one second block having at least one upper optical surface disposed above the lower optical surface, and
the at least one second block comprising a bottom limit.

The cleaning system comprises a device for discharging liquids as defined above.

According to yet another aspect, a driving assistance system comprising at least one cleaning system as defined above is proposed.

Further advantages and features of the invention will become apparent from studying the detailed description of entirely nonlimiting embodiments and the appended drawings, in which:

FIG. 1 schematically illustrates an exemplary embodiment of a motor vehicle having a driving assistance device.

FIG. 2 schematically illustrates an exemplary embodiment of a driving assistance device comprising a device for discharging liquids according to the invention.

FIG. 3 schematically illustrates an exemplary embodiment of a device for discharging liquids according to the invention.

FIG. 4 schematically illustrates an exemplary embodiment of a driving assistance device and of a corresponding device for discharging liquids according to the invention.

FIG. 5 schematically illustrates another exemplary embodiment of a driving assistance device and of a corresponding device for discharging liquids according to the invention.

The reference 1 in FIG. 1 denotes a vehicle, in this case for example a motor vehicle, comprising a driving assistance device 2.

The driving assistance device 2 has one or more modules, in this case for example one or more detection modules 3 configured to collect different information relating to the environment around the vehicle 1.

The detection module(s) 3 may be disposed at one or more locations on the vehicle 1, for example in the region of the roof, of the windshield, of the rear and/or front bumpers of the vehicle 1.

By way of nonlimiting example, the detection modules 3 may for example include
long-range laser sensors/transmitters of the LIDAR (“Laser Imaging, Detection and Ranging”) type configured to detect the environment,
viewing cameras having different levels of range,
front sensors/transmitters configured to measure the distance between the vehicle 1 and the vehicles ahead of it,
angle sensors/transmitters configured to monitor movements around the vehicle,
ultrasonic sensors/transmitters configured to detect obstacles in the vicinity of the vehicle, and
180° panoramic cameras configured to allow the driver and passengers of the vehicle 1 to view the environment around the vehicle.

Some of the sensors/transmitters mentioned above may be, for example, disposed in one and the same location of the vehicle 1 in order to reduce the space requirement of the detection module(s) 3.

For reasons of simplification, only one detection module 3 of the driving assistance device 2 is illustrated in FIG. 1, being for example disposed in the region of the roof of the vehicle 1 in this case.

Reference will now be made to FIG. 2 for schematically illustrating an exemplary embodiment of the detection module 3.

In this example, the detection module 3 has

a first sensor/transmitter 21, in this case for example a laser sensor of the LIDAR type,

a second sensor/transmitter 22, in this case for example a long-range viewing camera, disposed above the first sensor/transmitter 21, and

a third sensor/transmitter 23, in this case for example a medium-range viewing camera, likewise disposed above the first sensor/transmitter 21 and next to the second sensor/transmitter 22.

The first sensor/transmitter 21 has a first optical surface 21s having a top limit 21h. The second and third sensors/transmitters 22, 23 have a second optical surface 22s and a third optical surface 23s, respectively. The second and third optical surfaces 22s, 23s have a second bottom limit 22l and a third bottom limit 23l, respectively. The third bottom limit 23l is in this case disposed for example at a higher level than the second bottom limit 22l.

In the example illustrated in FIG. 2, the first, second and third optical surfaces 21s, 22s and 23s are flat surfaces and lie substantially in one and the same vertical plane.

Each of the second and third bottom limits 22l, 23l covers at least a part of the first top limit 21h of the first optical surface 21s. In this case, the combination of the second and third bottom limits 22l, 23l covers more or less the entire first top limit 21h of the first optical surface 21s.

The driving assistance device 2 also comprises, for each detection module 3, at least one cleaning system, in this case for example a cleaning system 4 for the detection module 3.

The cleaning system 4 comprises one or more cleaning devices 5 such as wipers configured to clean the first, second and third optical surfaces 21s, 22s, 23s of the detection module 3 and a device 6 for discharging liquid.

The device 6 for discharging liquids is configured to avoid a situation in which in particular dirty liquids run from the at least one upper optical surface of the detection module 3, in this case the second and third optical surfaces 22s, 23s, toward an optical surface disposed beneath said at least one upper optical surface, in this case the first optical surface 21s.

In other words, the device 6 for discharging liquids is configured to discharge the liquids running off the second and third optical surfaces 22s, 23s toward an area other than the first optical surface 21s.

It should be noted that said liquids may be for example used and dirty cleaning liquids that have been used for cleaning the second and third optical surfaces 22s, 23s or raindrops on these second and third optical surfaces 22s, 23s.

By way of example, if the first, second and third optical surfaces 21s, 22s, 23s are disposed on the front face of the detection module 3, the device 6 for discharging liquids may be configured to discharge said liquids toward the side faces or the rear face of the detection module 3.

Since the third bottom limit 23l is situated at a higher horizontal level than that of the second bottom limit 22l, the device 6 for discharging liquids is also configured to discharge liquids running off the third optical surface 23s toward an area other than the second optical surface 22s.

The device 6 for discharging liquids extends from an area 7 delimited by at least a part of the second or third bottom limit 22l, 23l of the at least one second or third optical surface 22s, 23s and said first top limit 21h of the first optical surface 21s.

In other words, the device 6 for discharging liquids may extend from a part of the second or the third bottom limit 22l or 23l or from a part of the first top limit 21h, or from a location between the second or the third bottom limit 22l, 23l of a second or of a third optical surface 22s, 23s and the first top limit 21h as long as the liquids running off the second and/or the third optical surface 22s, 23s are discharged toward an area other than the first optical surface 21s.

By way of nonlimiting example, the first, second and third optical surfaces 21s, 22s, 23s may also not be disposed in one and the same vertical plane. In that case, the shape of the device 6 for discharging liquids is designed to discharge said liquids toward an area other than the first and second optical surfaces 21s, 22s.

Reference will now be made to FIG. 3 for illustrating an exemplary embodiment of the device 6 for discharging liquids.

It should be noted that the device 6 for discharging liquids may be made in different embodiments, for example channels on their own or channels in combination with drainage pipes, known to a person skilled in the art.

By way of indication, the device 6 has a channel 8 extending from the bottom limit of an optical surface, in this case for example the third bottom limit 23l of the third optical surface 23s in the form of a semi-open cavity that opens upwardly.

The channel 8 comprises

a base 9, one lateral side 9a of which is secured to the third bottom limit 23l, and

a side wall 10 secured to the other lateral side 9b of the base 9.

A central discharging duct 11 is therefore formed by the base 9, the side wall 10 and the third bottom limit 23l.

It should be noted that the channel 8 may be secured to at least a part of the third bottom limit 23l by any means known to a person skilled in the art, for example by glue, by welding, or by mechanical holding.

The channel 8 may also have drainage pipes (not shown) connected to longitudinal ends of the central discharging duct 11 so as to discharge used and dirty liquids toward an area other than the first and second optical surfaces 21s, 22s.

In order to make it easier to discharge liquids, the channel 8 may also be inclined with respect to the horizontal H, in this case for example inclined from the mid-point M of the channel 8 toward the two longitudinal ends of the central discharging duct 11.

The channel 8 may for example be molded from plastic in one piece, or be attached by welding or by any other fastening means known to a person skilled in the art.

The dimensions of the central discharging duct 11 and of any drainage pipes may be designed in an adaptive manner so as to achieve an intended liquid discharging flow rate.

Reference will now be made to FIG. 4 for illustrating another embodiment of the driving assistance device 2 and of the corresponding device 6 for discharging liquids.

The driving assistance device 2 is fastened to the roof of a vehicle and centered on the roof of the vehicle and comprises a detection module 3 comprising at least two sensors/transmitters, in this case for example a fourth sensor/transmitter 24 and a fifth sensor/transmitter 25 which are superposed one on top of the other along an axis of rotation 12.

It should be noted that the position and the number of sensor(s)/transmitter(s) could be different that those presented in FIG. 4, without having a negative effect on the scope of the invention.

By way of example, the fourth sensor/transmitter 24 is a viewing camera and the fifth sensor/transmitter 25 is a LIDAR sensor.

The fourth sensor/transmitter 24 has a fourth optical surface 24s having a fourth top limit 24h and the fifth sensor/transmitter 25 has a fifth optical surface 25s having a fifth bottom limit 251.

The fourth optical surface 24s and the fifth optical surface 25s are in the longitudinal continuation of one another, such that one or the other does not protrude radially with respect to the other optical surface.

The driving assistance device 2 also comprises a cleaning system 4 having a cleaning device 5 mounted so as to be rotatable about the axis of rotation 12. The rotational movement is illustrated by arrows 13.

The cleaning device 5 comprises a first cleaning assembly 41, a second cleaning assembly 42, and a device 43 for driving these two cleaning assemblies simultaneously in rotation, which has a crank 44 and an electric motor 45.

The first cleaning assembly 41 is intended to clean the fifth optical surface 25s of the fifth sensor/transmitter 25 by wiping and the second cleaning assembly 42 is intended to clean the fourth optical surface 24s of the fourth sensor/transmitter 24.

The electric motor 45 is able to drive the cleaning device 5 in rotation about the axis of rotation 12. In other words, the electric motor 45 simultaneously drives the first cleaning assembly 41 and the second cleaning assembly 42 in rotation.

The crank 44 connects the first cleaning assembly 41 and the second cleaning assembly 42 to the electric motor 45. The crank 44 comprises at least one main arm, in this case for example a main arm 48 extending radially with respect to the axis of rotation 12.

As illustrated in FIG. 4, the main arm 48 is disposed, in this exemplary embodiment, above the fifth sensor/transmitter 25.

The fifth optical surface 25s and the fourth optical surface 24s have a regular curved and semi-cylindrical shape, both being coaxial and centered on the axis of rotation 12.

The fourth and fifth optical surfaces 24s, 25s extend more or less through an angle of 180°, i.e. a half-cylinder, corresponding to the maximum field of view, of the fourth and fifth optical surfaces 24s, 25s, respectively.

The fourth sensor/transmitter 24 has a top wall 49 and the fifth sensor/transmitter 25 has a bottom wall 50. The top wall 49 is spaced apart from the bottom wall 50 so as to form a clearance zone 51 between the fourth and fifth sensors/transmitters 24, 25.

The clearance zone 51 represents a volume that extends radially from the axis of rotation 12. The clearance zone 51 stops in line with the fourth optical surface 24s and the fifth optical surface 25s.

The cleaning system 4 also has a device 6 for discharging liquids that is disposed starting from an area delimited by at least a part of the fifth bottom limit 251 and the fourth top limit 24h, in this case for example an area combining the fifth bottom limit 251, the fourth top limit 24h and the clearance zone 51.

By way of example, the device 6 for discharging liquids has a channel 8 that is disposed starting from the clearance zone 51 and has a regular curved and semi-cylindrical shape so as to adapt to the fourth top limit 24h.

The channel 8 may cover for example the entire fourth top limit 24 so as to discharge liquids running off the fifth optical surface 25s toward an area other than the fourth optical surface 24s.

The profile of the channel 8 may be designed so as not to impede the first and second cleaning assemblies 41, 42 and may for example be identical, namely in the form of a semi-open cavity, to the channel 8 illustrated in FIG. 3.

The size of the channel 8 may be determined in an adaptive manner so as to achieve an intended liquid discharging flow rate, in this case for example between 5 and 40 ml/s.

FIG. 5 illustrates a variant of the driving assistance device 2 according to FIG. 4.

In this exemplary embodiment, the main extension arm 48 of the cleaning device 5 is disposed in the clearance zone 51 and connected between the first cleaning assembly 41 and the second cleaning assembly 42.

The clearance zone 51 is configured such that the crank 43 can move in rotation about the axis of rotation 12 between a first end position and a second end position. In this case, the crank 43 is shown in the first end position, the second end position being situated around 180° from the first end position.

In order not to impede the movements of the main arm 48, the device 6 for discharging liquids may be disposed starting from the fourth top limit 24h and cover the entire fourth top limit 24h.

The structure of the device 6 for discharging liquids may be identical to or different than those illustrated in FIG. 3 and FIG. 4, and the size of the device 6 for discharging liquids may be determined in a manner adapted to an intended discharging flow rate.

It should be noted that the invention is not limited to the means and configurations described and illustrated above, but also extends to all equivalent means or configurations and to any technically functional combination of such means. In particular, the shape of the device 6 for discharging liquids may be modified without having a negative effect on the invention, provided that the device 6 for discharging liquids ultimately fulfills the same functionalities as those described in this document.

What is claimed is:

1. A sensor system for a vehicle, the system comprising:
a first sensor block having a lower optical surface with a top limit,
at least one second sensor block having at least one upper optical surface with a bottom limit, with the at least one upper optical surface disposed above the lower optical surface, and
a device for discharging liquid onto the first sensor block and the at least one second sensor block, the device extending from an area delimited by at least a part of the bottom limit of the at least one second block and the top limit of the first block, and being configured to discharge liquids running off the at least one upper optical surface toward an area other than the lower optical surface.

2. The system as claimed in claim 1, wherein the at least one second sensor block is superposed on the first sensor block, and each of the at least one upper optical surface and the lower optical surface are in the longitudinal continuation of one another.

3. The device as claimed in claim 1, wherein the at least one upper optical surface and the lower optical surface are disposed in a first part of the system and the device is configured to discharge liquids running off the at least one upper optical surface toward a second part of the system, with the second part being different than the first part.

4. The system as claimed in claim 3, wherein the first part is a front part of the system and the second part is a rear part of the system.

5. The system as claimed in claim 1, wherein the first sensor block is at a distance from the at least one second sensor block.

6. The system as claimed in claim 1, wherein the device is inclined with respect to a horizontal direction of the system.

7. The system as claimed in claim 1, further comprises at least one channel.

8. The system as claimed in claim 7, wherein the at least one channel includes a semi-open cavity, the semi-open cavity having a size of which is designed so as to have a liquid discharging flow rate of between 5 ml/s and 40 ml/s.

9. A cleaning system for a module, the module including
a first sensor block having a lower optical surface with a top limit and
at least one second sensor block having at least one upper optical surface with a bottom limit, with the at least one upper optical surface being disposed above the lower optical surface, the cleaning system comprising:
device for discharging liquids, the device extending from an area delimited by at least a part of the bottom limit of the at least one second block and the top limit of the first block, and being configured to discharge liquids running off the at least one upper optical surface toward an area other than the lower optical surface.

10. (canceled)
